(19) United States
(12) Patent Application Publication
(10) Pub. No.: US 2015/0151441 A1
(43) Pub. Date: Jun. 4, 2015

(54) Effortless kitchen knife

(71) Applicant: Kuo-Chen Tsai, Taipei (TW)

(72) Inventor: Kuo-Chen Tsai, Taipei (TW)

(21) Appl. No.: 14/096,019

(22) Filed: Dec. 4, 2013

(51) Int. Cl. B26B 3/02

(52) U.S. Cl. CPC B26B 3/02

(57) ABSTRACT

A kitchen knife is provided with a blade including an edge, a heel, a tang on the rear top portion of the blade, and an opening through the blade and situated under the tang; and a handle releasably secured to the tang by using rivets and including flared front and rear ends. The knife can reduce the distance from the point of application of force to the hand holding the handle, thereby can be used more effortlessly and reduce the chance of hand muscle injury.

### BACKGROUND OF THE INVENTION

1. Field of the Invention

The invention relates to cutting tools and more particularly to an effortless kitchen knife having a handle positioned on a rear portion of a spine of the blade.

2. Description of Related Art

In cooking, a kitchen knife is a cutting tool used in food preparation. A modern kitchen knife is a multi-purpose knife designed to perform well at many differing kitchen tasks, rather than excelling at any one in particular. It can be used for mincing, slicing, and chopping vegetables, slicing meat, and disjointing large cuts.

A conventional kitchen knife has a handle and a metal blade having a tang fastened in the handle. In cutting, torque can be seen as a distance from the edge of the blade to the hand holding the handle times the force exerted on the handle by a user. However, it is not labor-saving because the point of application of force (i.e., the edge of the blade) is relatively away from the hand. Thus, the need for improvement still exists.

### SUMMARY OF THE INVENTION

The object of the invention is to provide a kitchen knife comprising a blade including an edge, a heel, a tang on the rear top portion of the blade, and an opening through the blade and situated under the tang; and a handle releasably secured to the tang and including a flared front end.

The features and advantages of the invention will become apparent from the following detailed description taken with the accompanying drawings.

### BRIEF DESCRIPTION OF THE DRAWINGS

FIG. 1 is a perspective view of an effortless kitchen knife according to the invention;

FIG. 2 is an exploded view of the kitchen knife;

FIG. 3 is a side elevation of the kitchen knife;

FIG. 4 is a front end view of the kitchen knife; and

FIG. 5 is a sectional view taken along line A-A of FIG. 3.

### DETAILED DESCRIPTION OF THE INVENTION

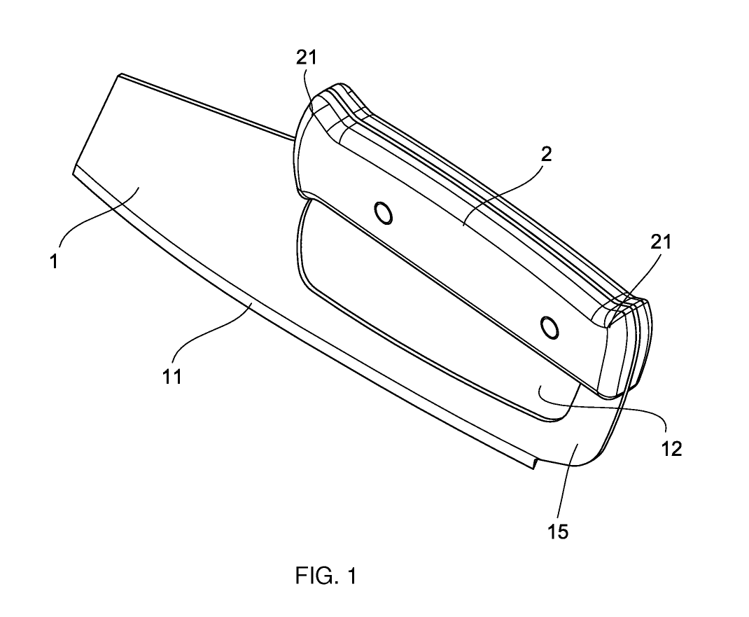

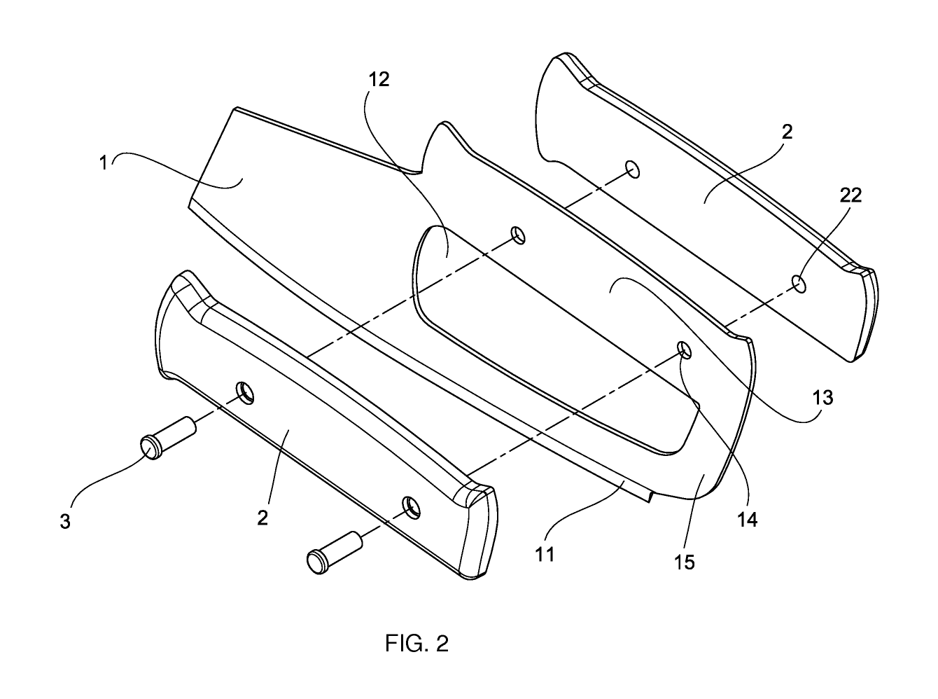

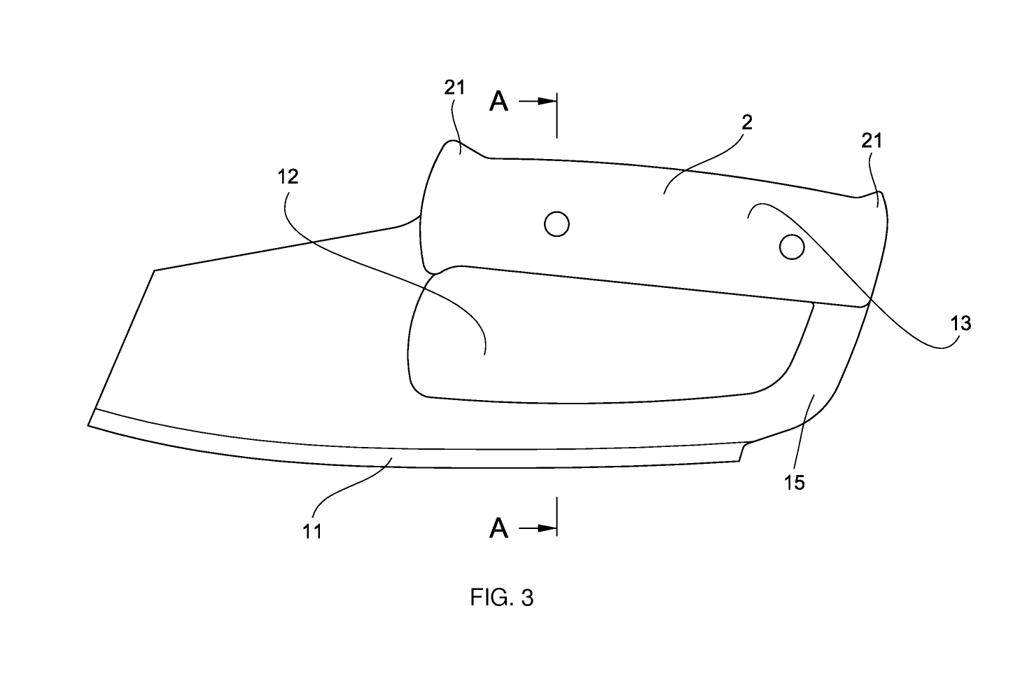

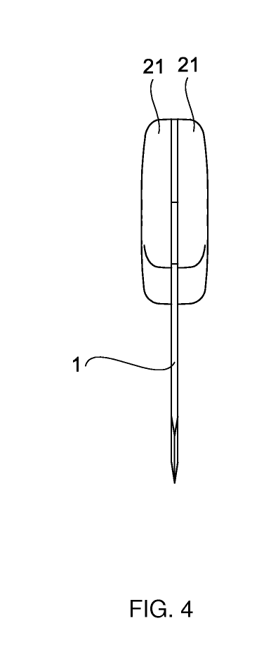

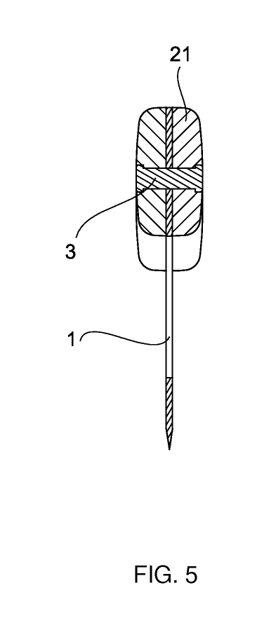

Referring to FIGS. 1 to 5, an effortless kitchen knife in accordance with the invention comprises the following components as discussed in detail below.

A blade 1 is made of steel, stainless steel, or ceramic and includes an edge 11 served as the entire cutting surface of the knife and extending from the front point to a heel 15, a tang 13 formed on a rear portion of a spine of the knife, two spaced holes 14 through the tang 13, and an opening 12 extending from an intermediate portion to the heel 15 and under the holes 14.

A handle 2 includes two portions each having two spaced pin holes 22 aligned with the holes 14 respectively and two flared parts 21 on front and rear ends respectively. Two rivets 3 are inserted through the pin holes 22 and holes 14 to fasten the handle 2 and the tang 13 (i.e., the blade 1) together.

It is envisaged by the invention that the flared parts 21 are not only ergonomic but also adapted to facilitate the holding of the handle 2 by the hand.

It is further envisaged by the invention that with the tang 13 formed integrally with the blade 1 and the handle 2 mounted on the tang 13 can, in cutting, reduce a distance from the edge 11 of the blade 1 (i.e., the point of application of force) to the hand holding the handle 2 (i.e., the tang 13), thereby can be used more effortlessly and reduce the chance of hand muscle injury.

While the invention has been described in terms of preferred embodiments, those skilled in the art will recognize that the invention can be practiced with modifications within the spirit and scope of the appended claims.

What is claimed is:

1. A kitchen knife comprising:
a blade including an edge, a heel, a tang on a rear top portion of the blade, and an opening through the blade and situated under the tang; and
a handle releasably secured to the tang and including a flared front end.

2. The kitchen knife of claim 1, wherein the blade further comprises two spaced through holes through the tang.

3. The kitchen knife of claim 2, wherein the handle further comprises two spaced pin holes aligned with the through holes respectively.

4. The kitchen knife of claim 3, further comprising two rivets inserted through the pin holes and the through holes to fasten the handle and the blade together.

5. The kitchen knife of claim 1, wherein the handle further comprises a flared rear end.
